(19) United States
(12) Patent Application Publication
(10) Pub. No.: US 2018/0204663 A1
(43) Pub. Date: Jul. 19, 2018

(54) INDUCTOR AND METHOD OF MANUFACTURING THE SAME

(71) Applicant: SAMSUNG ELECTRO-MECHANICS CO., LTD., Suwon-si (KR)

(72) Inventors: Jung Eun LEE, Suwon-si (KR); Kwang Sun CHOI, Suwon-si (KR); Min Jeong KIM, Suwon-si (KR); Jin Ho KU, Suwon-si (KR)

(21) Appl. No.: 15/728,114

(22) Filed: Oct. 9, 2017

(30) Foreign Application Priority Data
Jan. 18, 2017 (KR) 10-2017-0008631

(51) Int. Cl. H01F 27/28; H01F 27/255; H01F 41/04; H01F 41/02

(52) U.S. Cl. CPC H01F 27/2804; H01F 41/0206; H01F 41/041; H01F 27/255

(57) ABSTRACT

An inductor comprises an insulating substrate; a first internal coil portion disposed on one surface of the insulating substrate and a second internal coil portion disposed on the other surface of the insulating substrate opposed thereto; a via electrode penetrating through the insulating substrate to connect the first internal coil portion to the second internal coil portion; and a first via pad disposed on one surface of the insulating substrate and a second via pad disposed on the other surface of the insulating substrate, to cover the via electrode. Respective cross-sectional areas of an upper portion and a lower portion of the via electrode, in contact with the first via pad and the second via pad, are greater than a cross-sectional area of a central portion thereof. In addition, a method of manufacturing the inductor is provided.

### CROSS-REFERENCE TO RELATED APPLICATION

This application claims the benefit of priority to Korean Patent Application No. 10-2017-0008631, filed on Jan. 18, 2017 with the Korean Intellectual Property Office, the entirety of which is incorporated herein by reference.

### BACKGROUND

The present disclosure relates to an inductor and a method of manufacturing the same.

Inductors, components of a chip, are representative passive elements forming an electronic circuit, together with a resistor and a capacitor, to remove noise. Inductors may be used to form a resonance circuit, a filter circuit, or the like, amplifying a signal having a specific frequency band by being coupled to a capacitor using electromagnetic properties.

Recently, miniaturization and thinning of information technology (IT) devices, such as various communications devices and display devices, have been accelerated. Research into miniaturization and thinning of various elements, such as inductors, capacitors, and transistors, employed in IT devices, has been constantly undertaken.

Thus, inductors have been rapidly transformed into small, high-density chips allowing for automatic surface mounting. Thin film inductors, formed by mixing a magnetic powder and a resin on a coil pattern formed on an upper surface and a lower surface of a thin film insulating substrate using a plating process, have been developed.

Such thin film inductors may be manufactured in such a manner that a coil pattern is formed on an insulating substrate, and a magnetic substance material is disposed on an exterior thereof.

Since there is a limitation on a width of a coil in implementing miniaturization and thinning of inductors, it is difficult to secure an area of an internal core.

In the meantime, in the case of a substrate plating process in which a coil of an inductor is formed, a coil conductive pattern having a coil pattern may be formed on a surface of an insulating substrate. A coil conductive pattern having a coil pattern may be formed on an opposing surface of the insulating substrate.

Coil conductive patterns formed on the surface and on the opposing surface of the insulating substrate may be electrically connected to each other by a via electrode formed on the insulating substrate.

Via electrodes may be formed in such a manner that via holes are formed in a substrate using laser drilling. In a case in which via holes are formed using laser drilling, the via holes inevitably have a tapered form. To secure stable connectivity, sizes of the via holes and a via pad may be increased. Thus, since a size of a core is decreased, there may be a problem in implementing small, high-capacity inductors.

FIG. 1 is a schematic perspective view of an internal coil portion of an inductor 10 of the related art (e.g. FIGS. 1 and 2), while FIG. 2 is a cross-sectional view taken in an LW direction of FIG. 1.

With reference to FIGS. 1 and 2, in the case of a thin film inductor 10 of the related art (e.g. FIGS. 1 and 2), coils 41 and 42 may be connected to each other using a one-way via electrode 45 processing method. In the case of a one-way process, as illustrated in FIG. 1, since, due to a tapered form of a via hole, a size of a lower portion of a via electrode 45 is reduced, a possibility of a connectivity defect may be increased.

In order to reduce the occurrence of such connectivity defects, an area of a lower portion of a via electrode 45 should be secured. In a case in which a via electrode 45 is formed to have a larger size, sizes of via pads 43 and 44 may also be increased. Thus, a size of an internal core 55 may be reduced, so that there may be a significant limitation in implementing high-capacity inductors.

Thus, it is necessary to implement inductors which are small and may secure sufficient capacity.

### SUMMARY

An aspect of the present disclosure provides an inductor preventing a loss of inductance according to a reduction in an area of a core in such a manner that an area of a via pad is reduced by changing a form of a via electrode.

According to an aspect of the present disclosure, an inductor comprises an insulating substrate; a first internal coil portion disposed on one surface of the insulating substrate and a second internal coil portion disposed on the other surface of the insulating substrate opposed thereto; a via electrode penetrating through the insulating substrate to connect the first internal coil portion to the second internal coil portion; and a first via pad disposed on one surface of the insulating substrate and a second via pad disposed on the other surface of the insulating substrate, to cover the via electrode. Respective cross-sectional areas of an upper portion and a lower portion of the via electrode, in contact with the first via pad and the second via pad, are greater than a cross-sectional area of a central portion thereof.

According to another aspect of the present disclosure, a method of manufacturing an inductor comprises providing an insulating substrate; forming a first via hole in a direction from one surface of the insulating substrate to a central portion; connecting the first via hole to a second via hole after the second via hole is formed in a direction from the other surface of the insulating substrate to the central portion; forming a via electrode by filling the first via hole and the second via hole with an electrode material; forming a first via pad and a second via pad on the insulating substrate to cover a first internal coil portion, a second internal coil portion, and the via electrode; and forming a magnetic body by covering the first internal coil portion and the second internal coil portion with a magnetic substance.

### BRIEF DESCRIPTION OF DRAWINGS

The above and other aspects, features, and advantages of the present disclosure will be more clearly understood from the following detailed description when taken in conjunction with the accompanying drawings, in which:

FIG. 1 shows a schematic perspective view of an internal coil portion of an inductor of the related art;

FIG. 2 shows a cross-sectional view taken in an LW direction of FIG. 1;

FIG. 3 shows a schematic perspective view of an internal coil portion of an inductor according to an exemplary embodiment;

FIG. 4 shows a cross-sectional view taken in an LW direction of FIG. 3;

FIG. 5 shows a cross-sectional view taken along line I-I′ of FIG. 3;

FIG. 6 shows an enlarged cross-sectional view of portion A of FIG. 5;

FIGS. 7A to 7E show cross-sectional views illustrating a process of forming a via electrode of an inductor in sequence according to an exemplary embodiment; and

FIGS. 8, 9, 10, 11, and 12 show the embodiments of the present application.

### DETAILED DESCRIPTION

Hereinafter, embodiments of the present disclosure will be described as follows with reference to the attached drawings. The present disclosure may, however, be exemplified in many different forms and should not be construed as being limited to the specific embodiments set forth herein. Rather, these embodiments are provided so that this disclosure will be thorough and complete, and will fully convey the scope of the disclosure to those skilled in the art.

Hereinafter, embodiments of the present disclosure will be described with reference to schematic views illustrating embodiments of the present disclosure. In the drawings, for example, due to manufacturing techniques and/or tolerances, modifications of the shape shown may be estimated. Thus, embodiments of the present disclosure should not be construed as being limited to the particular shapes of regions shown herein, for example, to include a change in shape results in manufacturing. The following embodiments may also be constituted by one or a combination thereof.

The contents of the present disclosure described below may have a variety of configurations and propose only a required configuration herein, but are not limited thereto.

Inductor

Hereinafter, an inductor according to an exemplary embodiment will be described, and in detail, a thin film inductor will be described. However, an exemplary embodiment is not limited thereto.

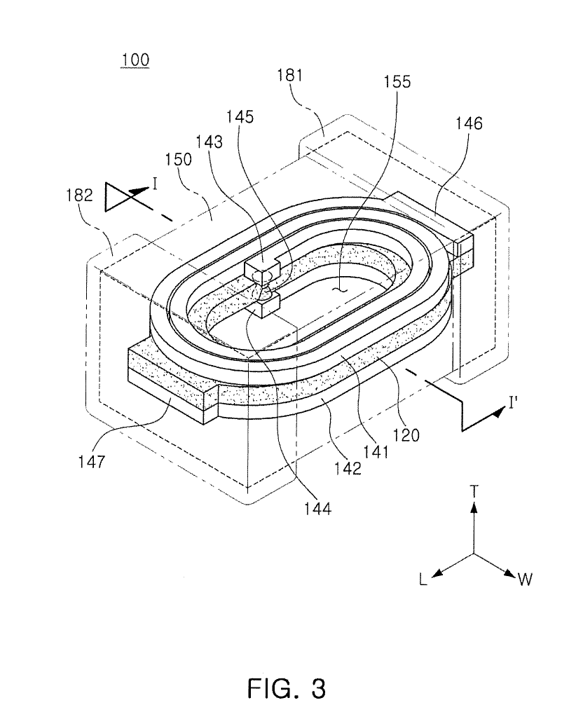

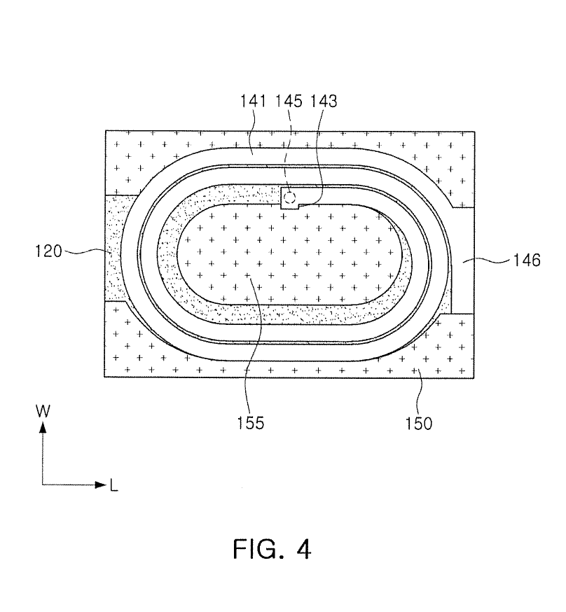

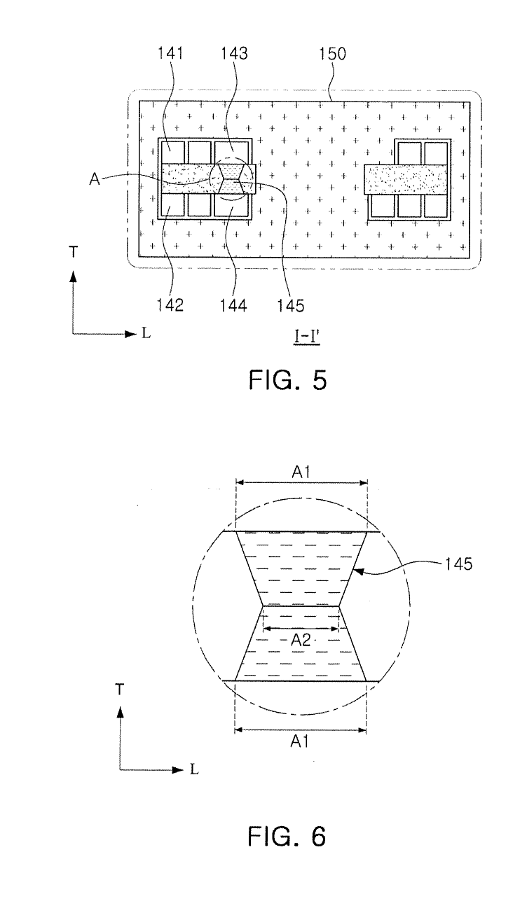

FIG. 3 shows a schematic perspective view of an internal coil portion of an inductor according to an exemplary embodiment. FIG. 4 shows a cross-sectional view taken in an LW direction of FIG. 3. FIG. 5 shows a cross-sectional view taken along line I-I′ of FIG. 3. FIG. 6 shows an enlarged cross-sectional view of portion A of FIG. 5.

With reference to FIGS. 3 and 4, a thin film inductor used in a power line of a power supply circuit may be provided as an example of an inductor.

An inductor 100 according to an exemplary embodiment may include a magnetic body 150, first and second internal coil portions 141 and 142 embedded in the magnetic body 150, and a first external electrode 181 and a second external electrode 182, disposed on an exterior of the magnetic body 150 to be electrically connected to the first and second internal coil portions 141 and 142.

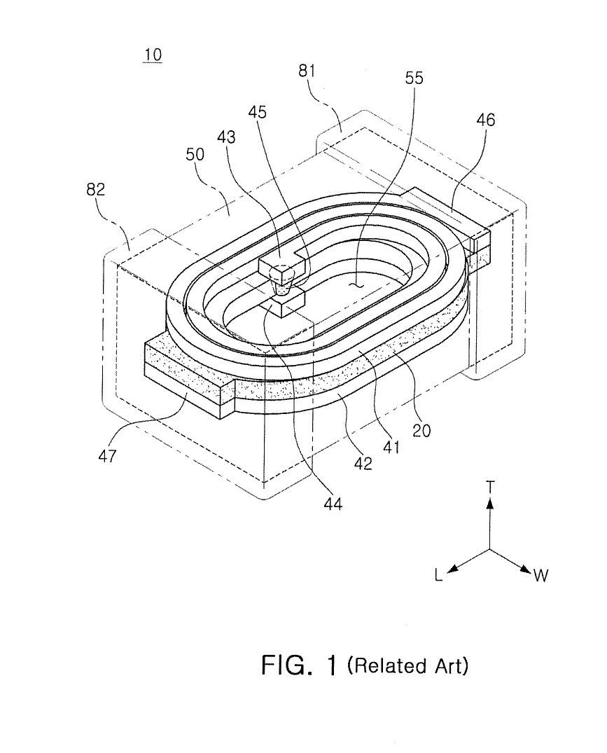

In the inductor 100 according to an exemplary embodiment, a ‘length’ direction is defined as an ‘L’ direction of FIG. 1, a ‘width’ direction is defined as a ‘W’ direction, and a ‘thickness’ direction is defined as a ‘T’ direction.

Any material forming an exterior of the inductor 100 and having a magnetic property may be provided as the magnetic body 150. For example, the magnetic body 150 may be formed in such a manner that the magnetic body 150 is filled with ferrite or a magnetic metal powder.

For example, the ferrite may be provided as manganese (Mn)-zinc (Zn)-based ferrite, nickel (Ni)—Zn-based ferrite, Ni—Zn-copper (Cu)-based ferrite, Mn-magnesium (Mg)-based ferrite, barium (Ba)-based ferrite, lithium (Li)-based ferrite, or the like.

The magnetic metal powder may include one or more selected from a group consisting of iron (Fe), silicon (Si), chrome (Cr), aluminum (Al), and Ni. For example, the magnetic metal powder may be provided as an Fe—Si-boron (B)—Cr-based amorphous metal, but is not limited thereto.

A diameter of a particle of the magnetic metal powder may be in a range of 0.1 m to 30 μm. The magnetic metal powder may be included in a thermosetting resin, such as an epoxy resin and a polyimide, in such a manner that the magnetic metal powder is distributed therein.

A first internal coil portion 141 having a coil form may be formed on one surface of an insulating substrate 120 disposed in a magnetic body 150. A second internal coil portion 142 having a coil form may be formed on the other surface opposing the one surface of the insulating substrate 120.

The first internal coil portion 141 and the second internal coil portion 142 may be formed to have a spiral form and may be formed by performing an electroplating method.

In detail, the insulating substrate 120 may be formed as a polypropylene glycol (PPG) substrate, a ferrite substrate, a metal-based soft magnetic substrate, or the like.

A through hole may be formed in a central portion of the insulating substrate 120, and the through hole may be subsequently filled with a magnetic material to form a core 155.

The core 155 filled with the magnetic material may be formed, thereby improving inductance Ls.

With reference to FIG. 5, the first internal coil portion 141 and the second internal coil portion 142, formed on the one surface of the insulating substrate 120 and the other surface may be connected to each other through a via electrode 145 formed by penetrating through the insulating substrate 120.

A first via pad 143 and a second via pad 144 may be formed on one surface of the insulating substrate 120 and the other surface, respectively, to cover the via electrode 145.

The first via pad 143 may be formed in such a manner that an end portion of the first internal coil portion 141 is extended. The second via pad 144 may be formed in such a manner that an end portion of the second internal coil portion 142 is extended.

The first via pad 143 and the second via pad 144 may be formed by performing the electroplating method, in the same manner as the first internal coil portion 141 and the second internal coil portion 142.

In general, a via electrode may be disposed to be in line with a portion of an internal coil. An open defect may occur due to dislocation of the via electrode.

In order to prevent the open defect, an area of a via pad tends to be relatively large, when a via pad is formed, which has been a limitation in implementing a miniaturized and high-capacity component of a chip.

The via electrode may be formed in such a manner that via holes are formed in a substrate using laser drilling. In a case in which the via holes are formed using laser drilling, the via holes inevitably have a tapered form. To secure stable connectivity, sizes of the via holes and a via pad may be increased. Thus, since a size of a core is decreased, there may be a problem in implementing a small, high-capacity inductor.

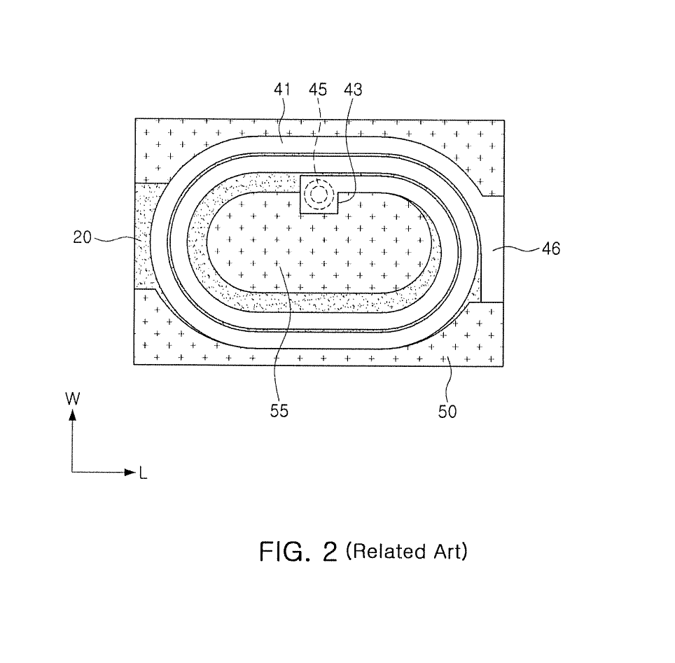

As illustrated in FIGS. 1 and 2, in the case of a thin film inductor 10 of the related art, coils 41 and 42 may be connected to each other using a one-way via electrode processing method. In the case of a one-way process, since, due to a tapered form of a via hole, a size of a lower portion of a via electrode 45 is reduced, a possibility of a connectivity defect may be increased.

In order to reduce the connectivity defect, an area of a lower portion of the via electrode should be secured. In a case in which the via electrode is formed to have a larger size, sizes of via pads 43 and 44 may also be increased. Thus, a size of an internal core 55 may be reduced, so that there may be a significant limitation in implementing a high-capacity inductor.

In other words, as areas of the via pads 43 and 44 are increased, an area of the core 55 may be reduced, and a density of the magnetic substance filling the core may be reduced, thereby degrading characteristics of inductance Ls.

According to an exemplary embodiment, in order to solve a problem described above, each of via holes may be formed in two directions from both of an upper portion and a lower portion of the insulating substrate 120, thereby simultaneously reducing sizes of the via electrode 145 and the via pads 143 and 144 (see e.g. FIG. 3). Thus, since a sufficient area in the core 155 may be secured, a loss of inductance caused by a reduction in the area of the core may be prevented.

In detail, with reference to FIG. 6, in the inductor according to an exemplary embodiment, respective cross-sectional areas of an upper portion and a lower portion of the via electrode 145, in contact with the first via pad 143 and the second via pad 144, may be greater than a cross-sectional area of a central portion of the via electrode 145.

In other words, as illustrated in FIG. 6, in a cross-sectional shape of the via electrode 145, a length A1 of the upper portion and the lower portion thereof, in contact with the first via pad 143 and the second via pad 144, may be greater than that of a central portion A2 thereof. Thus, respective cross-sectional areas of the upper portion and the lower portion of the via electrode 145, in contact with the first via pad 143 and the second via pad 144, may be greater than the cross-sectional area of the central portion thereof. The top and bottom lengths may be formed to be the approximately the same, equal, or unequal, depending on the demand of the properties of connectivity and resistivity of the via electrode 145

As described above, in a case in which a via hole is formed using laser drilling, a tapered form is inevitably generated. In this case, according to an exemplary embodiment, in a case in which via holes are formed in two directions from an upper portion and a lower portion of the insulating substrate 120, respective cross-sectional areas of the upper portion and the lower portion of the via electrode 145, in contact with the first via pad 143 and the second via pad 144, may be adjusted to be greater than the cross-sectional area of the central portion thereof.

As such, respective cross-sectional areas of the upper portion and the lower portion of the via electrode 145, in contact with the first via pad 143 and the second via pad 144, may be adjusted to be greater, with various magnitude depending on the required core size and coil size, than the cross-sectional area of the central portion thereof, thereby preventing an area of a lower portion of a via electrode from being reduced due to the tapered form, as in the case of the related art (e.g. FIGS. 1 and 2), and preventing cross-sectional areas of the upper portion and the lower portion of the via electrode 145 from being increased, as compared with the case of the related art (e.g. FIGS. 1 and 2).

Thus, since the first internal coil portion 141 and the second internal coil portion 142 have excellent electrical connectivity, while the sizes of the via pads 143 and 144 are not increased, a sufficient area in the core 155 may be secured.

According to an exemplary embodiment, since the sizes of the via pads 143 and 144 may be reduced, a sufficient area in the core may be secured, thereby preventing a loss of inductance.

In a case in which FIG. 2 is compared with FIG. 4, it can be confirmed that a size of a via pad 143 according to an exemplary embodiment has been reduced, as compared with that of a via pad 43 of an inductor of the related art (e.g. FIGS. 1 and 2). It can be confirmed that an inductor according to an exemplary embodiment may secure a sufficient area in the core, thereby allowing for high capacity.

With reference to FIG. 6, in the inductor 100 according to an exemplary embodiment, a cross section of the via electrode 145 may have a trapezoidal shape in a direction from the lower portion thereof to the central portion and may have a reversed trapezoidal shape in a direction from the central portion thereof to the upper portion.

According to an exemplary embodiment, as subsequently described, when the via electrode 145 is formed, the via holes may be formed in two directions from the upper portion and the lower portion of the insulating substrate 120, and each of the via holes may be formed toward the central portion of the insulating substrate 120. Thus, each of the via holes formed in a direction from the upper portion of the insulating substrate 120 to the central portion and formed in a direction from the lower portion thereof to the central portion may have the tapered shape.

Thus, the cross section of the via electrode 145 may have a trapezoidal shape in the direction from the lower portion thereof to the central portion and may have a reversed trapezoidal shape in the direction from the central portion thereof to the upper portion.

The cross section of the via electrode 145 may have a trapezoidal shape in the direction from the lower portion thereof to the central portion and may have a reversed trapezoidal shape in the direction from the central portion thereof to the upper portion, so that the cross-sectional areas of the upper portion and the lower portion of the via electrode 145 may not be increased, as compared with a case of the related art (e.g. FIGS. 1 and 2).

Thus, since the first internal coil portion 141 and the second internal coil portion 142 have excellent electrical connectivity, while the sizes of the via pads 143 and 144 are not increased, a sufficient area in the core 155 may be secured.

According to an exemplary embodiment, cross-sectional areas of the upper portion and the lower portion of the via electrode 145, in contact with the first via pad 143 and the second via pad 144, may be equal or unequal, depending on the demand of resistivity and connectivity of the via electrode 145.

When the via electrode 145 is formed, the via holes may be formed in two directions from the upper portion and the lower portion of the insulating substrate 120, and each of the via holes may be formed to the central portion of the insulating substrate 120 using a separate process. Thus, cross-sectional areas of the upper portion and the lower portion of the via electrode 145, in contact with the first via pad 143 and the second via pad 144, may be equal.

Thus, since it is unnecessary to secure the area of the lower portion of the via electrode, in order to reduce a connectivity defect, as in the case of the related art (e.g. FIGS. 1 and 2), a sufficient area in the core 155 may be secured, thereby implementing a high capacity inductor.

The first via pad 143 and the second via pad 144 have no limitation on a shape thereof. Cross sections in the top view thereof may have a quadrangular shape and may have a circular shape in the same manner as a shape of the via electrode 145.

As described above, the shape of the via electrode 145 may be controlled, and the area of the core 155 may be increased, as compared with a case of the related art (e.g. FIGS. 1 and 2), thereby increasing a density of a magnetic substance filling the core 155. Thus, characteristics of inductance Ls may be improved.

In other words, even in the case in which the inductor is miniaturized, the shape of the via electrode 145 may be controlled, as described above, to be able to reduce the sizes of the via pads 143 and 144, thereby securing a relatively large area of the core. Thus, as the density of the magnetic substance filling the core 155 is increased, a high capacity inductor may be implemented.

The first internal coil portion 141, the second internal coil portion 142, the via electrode 145, the first via pad 143, and the second via pad 144 may be formed to include a metal having a relatively high degree of electrical conductivity, such as silver (Ag), palladium (Pd), Al, Ni, titanium (Ti), gold (Au), Cu, platinum (Pt), or alloys thereof.

With reference to FIG. 3, the other end portion of the first internal coil portion 141 may be extended to form a first lead-out portion 146 exposed on one end surface of the magnetic body 150 in a length L direction thereof. The other end portion of the second internal coil portion 142 may be extended to form a second lead-out portion 147 exposed on the other end surface of the magnetic body 150 in the length L direction.

However, an exemplary embodiment is not limited thereto, and the first lead-out portion 146 and the second lead-out portion 147 may be exposed on at least one surface of the magnetic body 150.

In order to be connected to the first lead-out portion 146 and the second lead-out portion 147, exposed on opposing end surfaces of the magnetic body 150 in the length L direction, the first external electrode 181 and the second external electrode 182 may be disposed on the opposing end surfaces of the magnetic body 150, respectively, in the length L direction.

The first external electrode 181 and the second external electrode 182 may be formed to include a metal having a relatively high degree of electrical conductivity, such as Ni, Cu, tin (Sn), Ag, or alloys thereof.

Method of Manufacturing Inductor

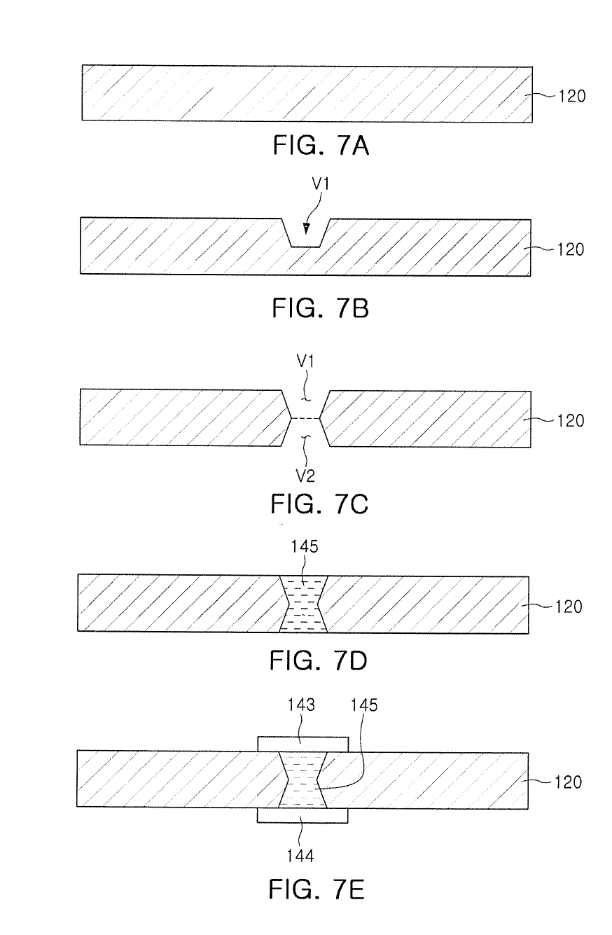

FIGS. 7A to 7E are cross-sectional views illustrating a process of forming a via electrode of the inductor in sequence according to an exemplary embodiment.

Hereinafter, with reference to FIGS. 7A to 7E, a method of manufacturing an inductor according to an exemplary embodiment will be described.

With reference to FIG. 7A, an insulating substrate 120 may first be provided.

In detail, the insulating substrate 120 may be provided as a PPG substrate, a ferrite substrate, a metal-based soft magnetic substrate, or the like.

A through hole may be formed in a central portion of the insulating substrate 120, and the through hole may be subsequently filled with a magnetic material to form a core (not illustrated in FIGS. 7A to 7E).

The core (not illustrated in FIGS. 7A to 7E) filled with the magnetic material may be formed, thereby improving inductance Ls.

Subsequently, with reference to FIG. 7B, a first via hole V1 may be formed in a direction from one surface of the insulating substrate 120 to a central portion thereof.

A method of forming the first via hole V1 is not specifically limited, and for example, may be performed using a laser, a punching machine, or the like.

The first via hole V1 may be formed in the direction from the one surface of the insulating substrate 120 only to the central portion thereof, in a manner different from a case of the related art (e.g. FIGS. 1 and 2).

Subsequently, with reference to FIG. 7C, a second via hole V2 may be formed in a direction from the other surface of the insulating substrate 120 to the central portion thereof, in order to be connected to the first via hole V1.

A method of forming the second via hole V2 may be performed in the same manner as the method of forming the first via hole V1 and for example, may be performed using a laser, a punching machine, or the like.

The second via hole V2 may be formed in the direction from the other surface of the insulating substrate 120 only to the central portion thereof, in a manner different from a case of the related art (e.g. FIGS. 1 and 2).

Subsequently, with reference to FIG. 7D, the first via hole V1 and the second via hole V2 may be filled with an electrode material to form a via electrode 145.

Subsequently, with reference to FIG. 7E, a first via pad 143 and a second via pad 144 may be formed on the insulating substrate 120 to cover a first internal coil portion and a second internal coil portion (not illustrated in FIGS. 7A to 7E) and the via electrode 145.

Finally, the first internal coil portion and the second internal coil portion may be covered with a magnetic substance to form a magnetic body, and an external electrode may be formed on opposing sides of the magnetic body using a paste for an external electrode, thereby manufacturing the inductor.

Except for descriptions above, descriptions overlapping with characteristics of the inductor according to an exemplary embodiment are omitted herein.

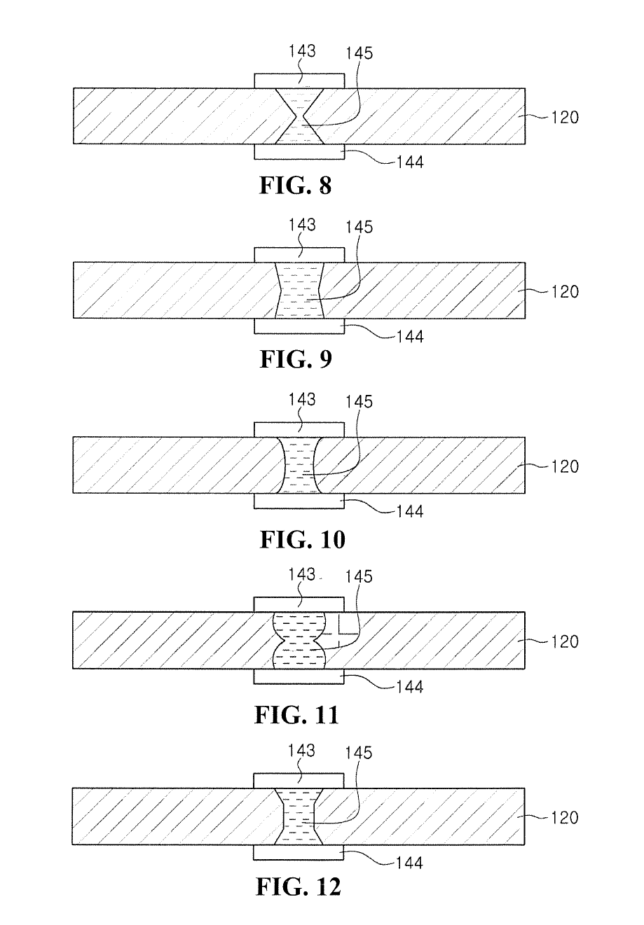

FIGS. 8, 9, 10, 11, and 12 show the embodiments of the present application. By choosing different parameters of the laser drill, such as focus, intensity, focal shape, chamber atmosphere, etc., and/or with chemical and mechanical etch/polishing, different cross-sectional shapes can be formed to fulfill different demands of resistivity and connectivity of the via electrode 145. That is, FIG. 8 shows the embodiment formed to have a narrow central portion, FIG. 9 shows the embodiment formed to have a broad central portion, FIG. 10 shows the embodiment formed to have a concave central portion, FIG. 11 shows the embodiment formed to have double convex upper and lower portions, and FIG. 12 shows the embodiment formed to have a three portions in which the central portion is formed to have a relatively vertical sidewalls so that the slope of the sidewall of the central portion is different from that of the upper and lower portions.

As set forth above, according to exemplary embodiments in the present disclosure, via holes may be formed in two directions from an upper portion and a lower portion of a substrate, thereby simultaneously reducing sizes of a via electrode and a via pad. Thus, since a sufficient area in a core may be secured, a loss of inductance caused by a reduction in an area of the core may be prevented.

While exemplary embodiments have been shown and described above, it will be apparent to those skilled in the art that modifications and variations could be made without departing from the scope of the present invention as defined by the appended claims.

What is claimed is:

1. An inductor, comprising:
an insulating substrate;
a first internal coil portion disposed on one surface of the insulating substrate and a second internal coil portion disposed on the other surface of the insulating substrate, opposing the one surface;
a via electrode penetrating through the insulating substrate to connect the first internal coil portion to the second internal coil portion; and
a first via pad disposed on one surface of the insulating substrate and a second via pad disposed on the other surface of the insulating substrate, to cover the via electrode,
wherein respective cross-sectional areas of an upper portion and a lower portion of the via electrode, in contact with the first via pad and the second via pad, are greater than a cross-sectional area of a central portion of the via electrode.

2. The inductor of claim 1, wherein a cross section of the via electrode has a trapezoidal shape in a direction from the lower portion of the via electrode to the central portion and a reversed trapezoidal shape in a direction from the central portion to the upper portion.

3. The inductor of claim 1, wherein the cross-sectional areas of the upper portion and the lower portion of the via electrode, in contact with the first via pad and the second via pad, are equal.

4. The inductor of claim 1, wherein one end portion of the first internal coil portion is extended to form the first via pad, and one end portion of the second internal coil portion is extended to form the second via pad.

5. The inductor of claim 1, wherein the first internal coil portion, the second internal coil portion, the first via pad, and the second via pad are formed using a plating process.

6. The inductor of claim 1, further comprising a magnetic body encapsulating the first internal coil portion and the second internal coil portion,
wherein the magnetic body includes a magnetic metal powder.

7. The inductor of claim 1, wherein a through hole is disposed in a central portion of the insulating substrate, and the through hole is filled with a magnetic substance to form a core portion.

8. The inductor of claim 6, wherein the other end portions of the first internal coil portion and the second internal coil portion are extended to form a lead-out portion led out to a surface of the magnetic body.

9. A method of manufacturing an inductor, comprising:
providing an insulating substrate;
forming a first via hole in a direction from one surface of the insulating substrate to a central portion;
connecting the first via hole to a second via hole after the second via hole is formed in a direction from the other surface of the insulating substrate to the central portion;
forming a via electrode by filling the first via hole and the second via hole with an electrode material;
forming a first via pad and a second via pad on the insulating substrate to cover a first internal coil portion, a second internal coil portion, and the via electrode; and
forming a magnetic body by covering the first internal coil portion and the second internal coil portion with a magnetic substance.

10. The method of claim 9, wherein respective cross-sectional areas of an upper portion and a lower portion of the via electrode, in contact with the first via pad and the second via pad, are greater than a cross-sectional area of a central portion of the via electrode.

11. The method of claim 9, wherein a cross section of the via electrode has a trapezoidal shape in a direction from a lower portion of the via electrode to a central portion and a reversed trapezoidal shape in a direction from the central portion of the via electrode to an upper portion.

12. The method of claim 9, wherein cross-sectional areas of an upper portion and a lower portion of the via electrode, in contact with the first via pad and the second via pad, are equal.

13. The method of claim 9, wherein an end portion of the first internal coil portion is extended to form the first via pad, and an end portion of the second internal coil portion is extended to form the second via pad.

14. The method of claim 9, wherein the first internal coil portion, the second internal coil portion, the first via pad, and the second via pad are formed using a plating process.

15. The method of claim 9, wherein a through hole is disposed in a central portion of the insulating substrate, and the through hole is filled with a magnetic substance to form a core portion.

16. An inductor, comprising:
an insulating substrate;
a first internal coil portion disposed on one surface of the insulating substrate and a second internal coil portion disposed on the other surface of the insulating substrate, opposing the one surface;
a via electrode penetrating through the insulating substrate to connect the first internal coil portion to the second internal coil portion; and
a first via pad disposed on one surface of the insulating substrate and a second via pad disposed on the other surface of the insulating substrate, to cover the via electrode,
wherein respective lengths, along a major surface of the substrate, of an upper portion and a lower portion of the via electrode, in contact with the first via pad and the second via pad, are greater than a length, along a major surface of the substrate, of a central portion of the via electrode.

17. The inductor of claim 16, wherein the lengths of the upper and lower portions are equal to each other.

18. The inductor of claim 16, wherein the central portion has a concave cross-sectional shape.

19. The inductor of claim 16, wherein the central portion has a convex and concave cross-sectional shape.

20. The inductor of claim 16, wherein the central portion has a sidewall slope different from that of the upper and lower portions.
